(19) United States
(12) Patent Application Publication
(10) Pub. No.: US 2023/0409476 A1
(43) Pub. Date: Dec. 21, 2023

(54) CACHE SYSTEM SIMULATING METHOD, APPARATUS, DEVICE AND STORAGE MEDIUM

(71) Applicant: Beijing ESWIN Computing Technology Co., Ltd., Beijing (CN)

(72) Inventor: Yuping Chen, Beijing (CN)

(73) Assignee: Beijing ESWIN Computing Technology Co., Ltd., Beijing (CN)

(21) Appl. No.: 18/098,801

(22) Filed: Jan. 19, 2023

(30) Foreign Application Priority Data
Jun. 9, 2022 (CN) 202210648905.4

(51) Int. Cl. G06F 12/0804; G06F 12/0877; G06F 12/0873

(52) U.S. Cl. CPC G06F 12/0804; G06F 12/0873; G06F 12/0877

(57) ABSTRACT

A cache system simulating method, an apparatus, a device and a storage medium. The cache system simulating method includes: acquiring a cache system model; acquiring an instruction information record, in which the instruction information record includes a plurality of entries, each entry of the plurality of entries includes a request instruction and a first addressing address corresponding to the request instruction; reading at least one entry of the plurality of entries from the instruction information record; simulating access to the cache system model by using the request instruction and the first addressing address in each entry of the at least one entry to acquire statistical data of the cache system model; and updating the cache system model based on the statistical data. The cache system simulation method greatly reduces the workload for modeling, shortens the model convergence time, so that the performance data of the cache can be acquired quickly.

### CROSS-REFERENCE TO RELATED APPLICATION

The present application claims priority of the Chinese Patent Application No. 202210648905.4, filed on Jun. 9, 2022, the disclosure of which is incorporated herein by reference in its entirety as part of the present application.

### TECHNICAL FIELD

Embodiments of the present disclosure relate to a cache system simulating method, an apparatus, a device and a storage medium.

### BACKGROUND

In a common computer architecture, instructions and data of the program are all stored in a memory, and an operation frequency of a processor is much higher than an operation frequency of the memory, so it takes hundreds of clock cycles to acquire data or instructions from the memory, which usually causes the processor to idle due to inability to continue running related instructions, resulting in performance loss. In order to run fast and access efficiently, a high-speed cache storage apparatus (or briefly referred to as a cache) is usually adopted to save part of the data for high-speed reading by the processor. The data may be, for example, recently accessed data, pre-fetched data according to program operation rules, etc.

### SUMMARY

At least one embodiment of the present disclosure provides a cache system simulating method, which includes: acquiring a cache system model; acquiring an instruction information record, in which the instruction information record includes a plurality of entries, each entry of the plurality of entries includes a request instruction and a first addressing address corresponding to the request instruction; reading at least one entry of the plurality of entries from the instruction information record; simulating access to the cache system model by using the request instruction and the first addressing address in each entry of the at least one entry to acquire statistical data of the cache system model; and updating the cache system model based on the statistical data.

For example, in the cache system simulating method provided in at least one embodiment of the present disclosure, simulating the access to the cache system model by using the request instruction and the first addressing address in each entry of the at least one entry to acquire the statistical data of the cache system model, includes: mapping the first addressing address to the cache system model to acquire a count value in a statistics counter, in which the cache system model is set to have a first configuration parameter; and acquiring the statistical data according to the count value.

For example, in the cache system simulating method provided in at least one embodiment of the present disclosure, updating the cache system model based on the statistical data, includes: comparing the statistical data with target data to update the first configuration parameter.

For example, in the cache system simulating method provided in at least one embodiment of the present disclosure, the count value includes a first count value, the statistical data includes a first statistical value, mapping the first addressing address to the cache system model to acquire the count value in the statistics counter, includes: mapping m first addressing addresses into the cache system model, where m is an integer greater than 1; comparing the m first addressing addresses with address segments in a plurality of corresponding cache lines in the cache system model; and in response to a comparison result of i first addressing addresses being cache hit, updating the first count value in the statistics counter to i, where i is a positive integer not greater than m.

For example, in the cache system simulating method provided in at least one embodiment of the present disclosure, acquiring the statistical data according to the count value, includes: acquiring the first statistical value as i/m according to the first count value.

For example, in the cache system simulating method provided in at least one embodiment of the present disclosure, the target data includes a first target value, comparing the statistical data with the target data to update the first configuration parameter, includes: in response to the first statistical value being greater than or equal to the first target value, outputting the first configuration parameter as a target first configuration parameter; or in response to the first statistical value being less than the first target value, modifying the first configuration parameter.

For example, in the cache system simulating method provided in at least one embodiment of the present disclosure, the first statistical value is a hit ratio, and the first target value is a target hit ratio.

For example, in the cache system simulating method provided in at least one embodiment of the present disclosure, the count value includes a second count value, and the statistical data includes a second statistical value, mapping the first addressing address to the cache system model to acquire the count value in the statistics counter, includes: mapping n first addressing addresses into the cache system model, where n is an integer greater than 1; comparing the n first addressing addresses with address segments in a plurality of corresponding cache lines in the cache system model; and in response to a comparison result of j first addressing addresses being bank conflict, updating the second count value in the statistics counter to j, where j is a positive integer not greater than n.

For example, in the cache system simulating method provided in at least one embodiment of the present disclosure, acquiring the statistical data according to the count value includes: acquiring the second statistical value as j/n according to the second count value.

For example, in the cache system simulating method provided in at least one embodiment of the present disclosure, the target data includes a second target value, comparing the statistical data with the target data to update the first configuration parameter includes: in response to the second statistical value being less than or equal to the second target value, outputting the first configuration parameter as the target first configuration parameter; or in response to the second statistical value being greater than the second target value, modifying the first configuration parameter.

For example, in the cache system simulating method provided in at least one embodiment of the present disclosure, the second statistical value is a bank conflict ratio, and the second target value is a target bank conflict ratio.

For example, in the cache system simulating method provided in at least one embodiment of the present disclosure, the first configuration parameter includes way, set, bank or replacement strategy.

For example, in the cache system simulating method provided in at least one embodiment of the present disclosure, the request instruction includes a load request instruction or a store request instruction.

For example, the cache system simulating method provided in at least one embodiment of the present disclosure further includes: creating the cache system model by using a script language.

For example, in the cache system simulating method provided in at least one embodiment of the present disclosure, the instruction information includes trace log instruction information.

At least one embodiment of the present disclosure further provides an apparatus for cache system simulation, which includes: an acquiring circuit, configured to acquire a cache system model and acquire an instruction information record, in which the instruction information record includes a plurality of entries, each entry of the plurality of entries includes a request instruction and a first addressing address corresponding to the request instruction; a simulating access circuit, configured to read at least one entry of the plurality of entries from the instruction information record, simulate access to the cache system model by using the request instruction and the first addressing address in each entry of the at least one entry to acquire statistical data of the cache system model; and an updating circuit, configured to update the cache system model based on the statistical data.

At least one embodiment of the present disclosure further provides a device for cache system simulation, which includes: a processor; a memory, which includes computer programs; in which the computer programs are stored in the memory and configured to be executed by the processor, and the computer programs are configured to: implement the simulating method provided by any embodiment of the present disclosure.

At least one embodiment of the present disclosure further provides a storage medium, which is configured to store non-transitory computer readable instructions; when executed by a computer, cause the non-transitory computer readable instructions to implement the simulating method provided by any embodiment of the present disclosure.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1A is a schematic diagram of an example of a basic principle of a cache;

FIG. 1B is a schematic diagram of a mapping relationship principle between a memory and a cache in a direct association, a full association and a set association;

FIG. 1C is a schematic diagram of an organization form and an addressing mode of a set association of a cache;

FIG. 1D shows an operation principle of a cache of a multi-bank structure;

FIG. 2 is an exemplary flow chart of a cache system simulating method provided by at least one embodiment of the present disclosure;

FIG. 3 is an exemplary flow chart of step S40 in FIG. 2;

FIG. 4 is a schematic flow chart of an example of steps S30 to S50 in FIG. 2;

FIG. 5 is a schematic flow chart of another example of steps S30 to S50 in FIG. 2;

FIG. 6 is a schematic block diagram of an apparatus for cache system simulation provided by at least one embodiment of the present disclosure;

FIG. 7 is a schematic block diagram of a device for cache system simulation provided by at least one embodiment of the present disclosure;

FIG. 8 is a schematic block diagram of another device for cache system simulation provided by at least one embodiment of the present disclosure; and

FIG. 9 is a schematic diagram of a storage medium provided by at least one embodiment of the present disclosure.

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

Unless otherwise defined, all the technical and scientific terms used herein have the same meanings as commonly understood by one of ordinary skill in the art to which the present disclosure belongs. The terms “first,” “second,” etc., which are used in the present disclosure, are not intended to indicate any sequence, amount or importance, but distinguish various components. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

The present disclosure is described below through several specific embodiments. To keep the following description of the embodiments of the present disclosure clear and concise, detailed descriptions of well-known functions and well-known components may be omitted. When any component of an embodiment of the present disclosure appears in more than one drawing, the component is denoted by the same reference numeral in each drawing.

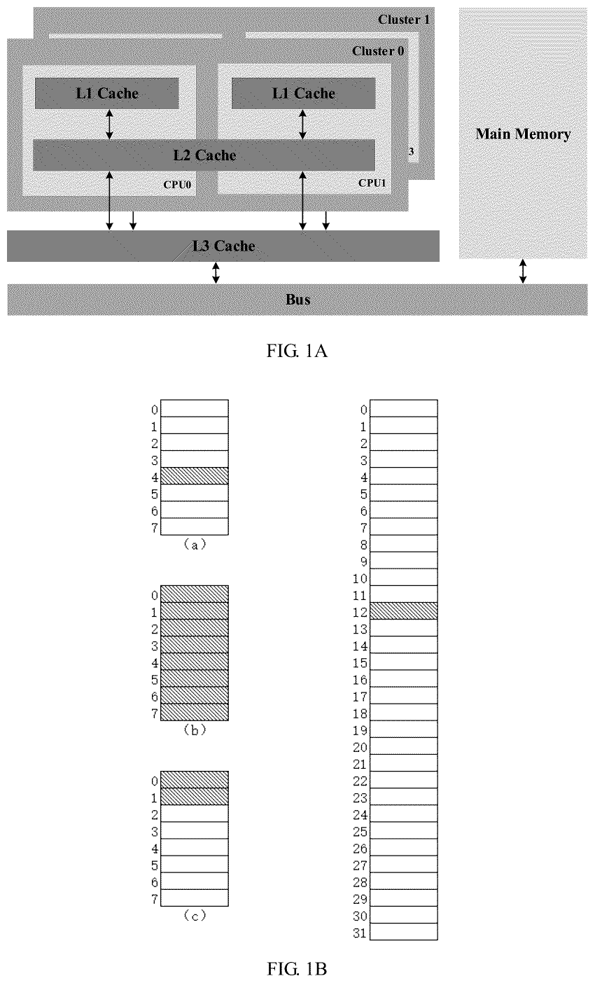

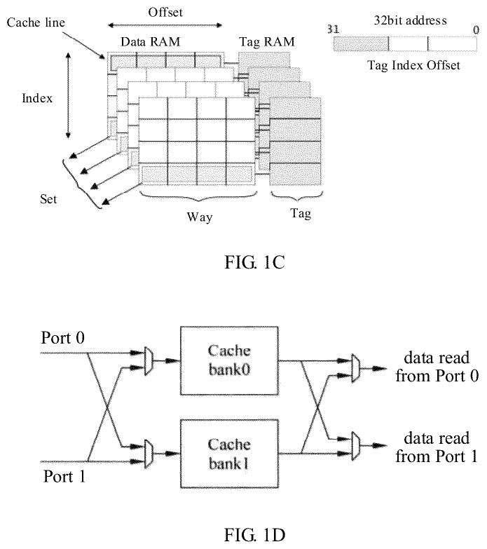

FIG. 1A is a schematic diagram of an example of a basic principle of a cache. For example, a computer usually includes a main memory and caches; as compared with an access speed of a cache, a processor (a processing core of a single-core CPU or a multi-core CPU) has a relatively slow access speed to the main memory. Therefore, the cache may be used to make up for the slow access speed to the main memory and improve the memory access speed.

For example, in a computing system shown in FIG. 1A, a plurality of levels of caches are adopted, for example, a first level cache (L1 Cache, also referred to as L1 cache), a second level cache (L2 Cache, also referred to as L2 cache), and a third level cache (L3 Cache, also referred to as L3 cache). The L1 Cache is private to a CPU. Each CPU has a L1 Cache, for example, in some CPUs, the L1 Cache may be further divided into L1 Cache dedicated to data (L1D Cache) and L1 Cache dedicated to instructions (L1I Cache); all CPUs (e.g., CPU0 and CPU1) in a cluster (e.g., cluster 0) share a L2 Cache, for example, the L2 Cache does not distinguish between instructions and data, and may cache both; the L3 Cache is connected with the main memory through a bus, for example, the L3 Cache does not distinguish between instructions and data and may cache both. Accordingly, the L1 Cache is the fastest, followed by the L2 Cache, and the L3 Cache is the slowest. When it is necessary to acquire data or an instruction, the processor firstly looks for the data or the instruction in the L1 Cache; if it is not found in the L1 Cache, the processor looks for the data or the instruction in the L2 Cache; if it is still not found, the processor looks for the data or the instruction in the L3 Cache; if the required data is not found in L1 Cache, L2 Cache and L3 Cache, then the processor looks for the data in the main memory. When the data or the instruction is acquired from a certain level of cache other than the L1 Cache or from the memory, in addition to being returned to the CPU for use, the data or the instruction may also be filled into a previous cache for temporary storage. A setting mode of caches in the CPU is not limited in the embodiments of the present disclosure.

Capacity of a cache is very small; content saved by a cache is only a subset of content of the main memory; and data exchange between the cache and the main memory is in blocks. To cache data in the main memory into the cache, for example, a certain function is used to locate a main memory address into the cache, which is referred to as address mapping. After the data in the main memory is cached in the cache according to the mapping relationship, the CPU converts the main memory address in a program into a cache address when executing the program. Address mapping modes of different types of caches usually include a direct mapping, a full association mapping, and a set association mapping.

Although the cache has smaller capacity than that of the main memory, it is much faster than the main memory, therefore, a main function of the cache is to store data that the processor may need to access frequently in the near future. In this way, the processor may directly read the data from the cache without frequently accessing the slower main memory, so as to improve the access speed to the memory of the processor. A basic unit of a cache is a cache line, which may be referred to as a cache block or a cache row. With respect to the cache being divided into a plurality of cache blocks, data stored in the main memory is divided in a similar dividing manner. The data blocks divided from the memory are referred to as memory blocks. Usually, a memory block may be 64 bytes in size, and a cache block may also be 64 bytes in size. It may be understood that, in practical applications, sizes of the memory block and the cache line may be set to other values, for example, 32 bytes to 256 bytes, as long as the size of the memory block is ensured to be the same as that of the cache block.

FIG. 1B is a schematic diagram of a mapping relationship principle between a memory and a cache in a direct association, a full association and a set association. Assume there are 32 items (memory blocks) in the memory and 8 items (cache blocks) in the cache. In the direct association mode, each memory block may only be placed in one location of the cache. Assume a 12th block of the memory is to be placed in the cache, since there are only 8 items in the cache, the 12th block may only be placed on a (12 mod 8=4)th item, and cannot be placed anywhere else; thus, it may be seen that memory blocks 4, 12, 20 and 28 all correspond to the 4th item of the cache; if there is a conflict, they may only be replaced. Hardware required in the direct connection mode is simple but inefficient, as shown by (a) in FIG. 1B. In the full association mode, each memory block may be placed in any location of the cache, so that memory blocks 4, 12, 20 and 28 may be placed in the cache at a same time. Hardware required in the full association mode is complex but efficient, as shown by (b) in FIG. 1B. The set association is a compromise between the direct association and the full association. Taking two ways of set association as an example, locations 0, 2, 4 and 6 in the cache are one way (referred to as way 0 here), and locations 1, 3, 5 and 7 are the other way (referred to as way 1 here); each way has 4 blocks. With respect to the 12th block of memory, since a remainder of 12 divided by 4 is 0, the 12th block may be placed in a 0th location of the 0th way of the cache (i.e., the 0th location of the cache) or in the 0th location of the 1st way (i.e., the 1st location of the cache), as shown by (c) in FIG. 1B.

FIG. 1C is a schematic diagram of an organization form and an addressing mode of a set association of a cache. As shown in FIG. 1C, the cache is organized as an array of cache lines. A column of cache lines forms a way, and a plurality of cache lines in a same location in the plurality of columns of cache lines form a set; a plurality of cache lines in a same set are equivalent to each other and are distinguished (or read and write) through different ways. A location (set, way, byte) of data or an instruction in the cache is acquired through a physical address of the data or the instruction to be read; and each physical address is divided into three portions:
(1) Index, which is used for selecting different sets in the cache; all cache lines in a same set are selected through a same index;
(2) Tag, which is used for selecting different cache lines in a same set; a tag portion in a physical address is compared with a tag of a cache line in each way; and if the tag portion matches to the tag of a cache line, it indicates cache hit, so that the cache line is selected; otherwise, it indicates cache miss;
(3) Offset, which is used for further selecting a corresponding address in the selected cache line, and represents an address difference (Offset) between a first byte of target data or instruction in the selected cache line and a first byte of the cache line., the corresponding data or instruction is read from the location of the byte.

In order to improve a hit ratio of the cache, it is necessary to store the most recently used data in the cache as much as possible. Because cache capacity is limited, when a cache space is full, a cache replacement strategy may be adopted to delete some data from the cache, and then write new data into the space freed. The cache replacement strategy is actually a data obsolescence mechanism. Using a reasonable cache replacement strategy may effectively improve the hit ratio. Common cache replacement strategies include, but are not limited to, a first in first out scheduling, a least recently used scheduling, a least frequently used scheduling, etc., which is not limited in the embodiments of the present disclosure.

For example, in a superscalar processor, in order to improve performance, the processor needs to be capable of simultaneously executing a plurality of load/store instructions in each cycle, which requires a multi-port cache. However, due to greater capacity of the multi-port cache, and due to the use of multi-port design, it has a great negative impact on area and speed of the chip; therefore, a multi-bank structure may be adopted.

FIG. 1D shows an operation principle of a cache of a multi-bank structure.

For example, as shown in FIG. 1D, the multi-bank structure divides the cache into several small banks, each bank has only one port. For example, a cache of dual ports (port 0 and port 1) as shown in FIG. 1D divides the cache into Cache bank 0 and Cache bank 1. If access addresses on a plurality of ports of the cache are located in different cache banks within a clock cycle, this will not cause any problem; only when addresses of two or more ports are located in a same cache bank, a conflict may occur, which is referred to as bank conflict. For example, the problem of bank conflict may be alleviated by selecting an appropriate number of banks.

With respect to the caches shown in FIG. 1A to FIG. 1D, how to set performance data such as way, set, bank or replacement strategy, etc. for caches of respective levels will directly affect a hit ratio and latency of a cache system. For example, a common cache system design method is modeling an entire Intellectual Property Core (IP core, also referred to as IP) of a Central Processing Unit (CPU) or a Graphics Processing Unit (GPU), setting appropriate performance data such as way, set, bank or replacement strategy etc. in a real cache design program, and running the program to acquire a hit ratio or bank conflict calculation result of the respective levels of cache; then further optimizing the setting of performance data such as way, set, bank or replacement strategy, etc. in the cache according to the hit ratio or bank conflict calculation result, until the hit ratio or bank conflict calculation result reaches a target value. However, the above-described cache system design method needs modeling the entire IP of the CPU or the GPU, which requires a lot of work and is not easy to converge, and has to run a real cache design program to acquire data such as hit ratio or bank conflict, which is limited by an instruction level architecture, resulting in a low computing speed.

At least one embodiment of the present disclosure provides a cache system simulating method. The method includes: acquiring a cache system model; acquiring an instruction information record, in which the instruction information record includes a plurality of entries, each entry of the plurality of entries includes a request instruction and a first addressing address corresponding to the request instruction; reading at least one entry of the plurality of entries from the instruction information record; simulating access to the cache system model by using the request instruction and the first addressing address in each entry of the at least one entry to acquire statistical data of the cache system model; and updating the cache system model based on the statistical data.

A plurality of embodiments of the present disclosure further provide an apparatus, a device or a storage medium corresponding to performing the above-described cache system simulating method.

The cache system simulating method, the apparatus, the device and the storage medium provided by at least one embodiment of the present disclosure separately model the cache system based on the instruction information record, without modeling the entire IP of the CPU or the GPU, which greatly reduces the workload for modeling, shortens the model convergence time, so that the performance data of the cache can be acquired quickly.

Hereinafter, at least one embodiment of the present disclosure will be described in detail with reference to the accompanying drawings. It should be noted that the same reference signs will be used in different drawings to refer to the same elements that have been described.

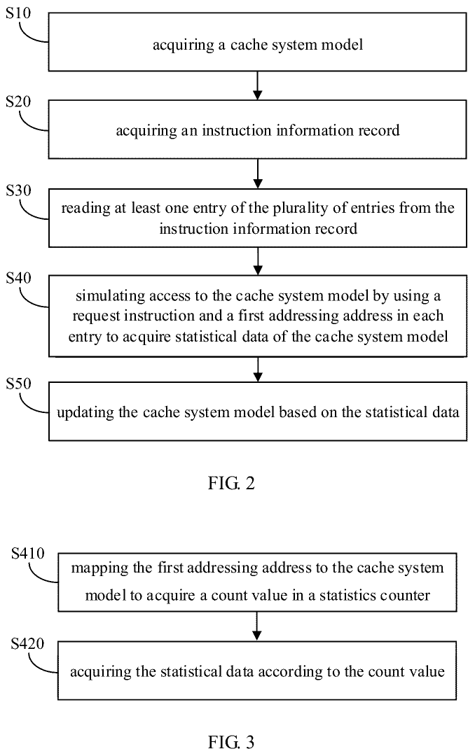

FIG. 2 is an exemplary flow chart of a cache system simulating method provided by at least one embodiment of the present disclosure.

For example, as shown in FIG. 2, at least one embodiment of the present disclosure provides a cache system simulating method; the cache system simulating method is used for design of a cache system. For example, the cache system simulating method includes steps S10 to S50 below.

Step S10: acquiring a cache system model;

Step S20: acquiring an instruction information record;

Step S30: reading at least one entry of the plurality of entries from the instruction information record;

Step S40: simulating access to the cache system model by using a request instruction and a first addressing address in each entry to acquire statistical data of the cache system model; and

Step S50: updating the cache system model based on the statistical data.

For example, in step S10, the acquired cache system model may be, for example, a multi-level cache as shown in FIG. 1A, or a certain level of cache therein; an address mapping mode of the cache may be a direct mapping, a full association mapping or a set association mapping, etc., which is not limited in the embodiments of the present disclosure.

For example, the cache system simulating method provided by at least one embodiment of the present disclosure further includes: creating the cache system model in step S10, for example, by using a script language. For example, the script language may be a perl language or a python language, or may also be other script languages that may implement a function of modeling the cache system, which is not limited in the embodiments of the present disclosure.

For example, in step S20, the instruction information record includes a plurality of entries; and each entry of the plurality of entries includes a request instruction (request) and a first addressing address (address) corresponding to the request instruction. For example, the request instruction includes a load request instruction (load) or a store request instruction (store); and the first addressing address may be an address carried by the load request instruction or the store request instruction.

For example, the instruction information record may include trace log instruction information (trace log); the trace log instruction information may be directly acquired through a hardware platform or an open source website. For example, an exemplary trace log instruction information may include the following contents:

| Cycle number | Request type | Address | Load data/Store data |
|---|---|---|---|
| 1 | load | 0x8000_0000 | 0x5555_5555 |
| 5 | store | 0x8000_0010 | 0x5a5a_5a5a |
| . . . | . . . | . . . | . . . |

In the embodiment of the present disclosure, the instruction information record, for example, the trace log instruction information, may be acquired through a hardware platform or an open source website, so that the cache system may be independently modeled by using the instruction information record. Since the instruction information record is easy to acquire, cache system simulation based on the instruction information has higher computing efficiency, and may undergo customized optimization as required by customers.

For example, in step S30, the at least one entry of the plurality of entries is read from the instruction information record, to acquire the request instruction and the first addressing address in each entry of the at least one entry. For example, the script language includes a system function for executing file reading; and information in the instruction information record may be directly read by calling the system function. For example, each time an entry in the instruction information record (e.g., a line in the trace log instruction information) is read, information such as the request instruction in the entry, the first addressing address corresponding to the request instruction, etc. may be acquired.

For example, in step S40, by using the request instruction and the first addressing address in each entry read, a process of accessing the cache system model may be simulated, for example, mapping of the first addressing address corresponding to the request instruction to ways, sets, banks, etc. in the cache is mainly completed; specifically, the first addressing address may be compared with an address segment (tag) in a plurality of cache lines corresponding to the cache system model, to acquire statistical data of the cache system model.

For example, the statistical data may be a hit ratio or a bank conflict ratio of the cache, or may also be other data which reflects a functional state of the cache system, which is not limited in the embodiments of the present disclosure.

For example, in step S50, one or more configuration parameters in the cache system model are updated based on the statistical data acquired in step S40, for example, address mapping or replacement strategies of ways, sets, or banks etc. in the cache are updated to achieve an optimal cache hit ratio and a minimum bank conflict.

In the cache system simulating method provided by the embodiments of the present disclosure, the cache system may be modeled independently based on the instruction information record, without modeling the entire IP of the CPU or the GPU, which greatly reduces the workload for modeling and shortens the model convergence time, so that the performance data of the cache can be acquired quickly.

FIG. 3 is an exemplary flow chart of step S40 in FIG. 2.

For example, by using the request instruction included in each entry of the at least one entries read from the instruction information record in step S30 and the first addressing address corresponding to the request instruction, access to the cache system model may be simulated to acquire the statistical data of the cache system model. For example, as shown in FIG. 3, step S40 in the simulating method shown in FIG. 2 includes steps S410 to S420 below.

Step S410: mapping the first addressing address to the cache system model to acquire a count value in a statistics counter;

Step S420: acquiring the statistical data according to the count value.

For example, in the embodiment of the present disclosure, the cache system model is set to have a first configuration parameter; and the first configuration parameter includes way, set, bank or replacement strategy, etc. For example, in step S410, the first addressing address may be mapped to the cache system model set to the first parameter, by providing the statistics counter in the cache system model, to update the count value of the statistics counter. For example, in step S410, the statistical data is acquired according to the count value; and step S410 further includes: comparing the statistical data with target data to update the first configuration parameter. For example, the first configuration parameter of the cache is updated to make the statistical data reach an allowable range of the target data.

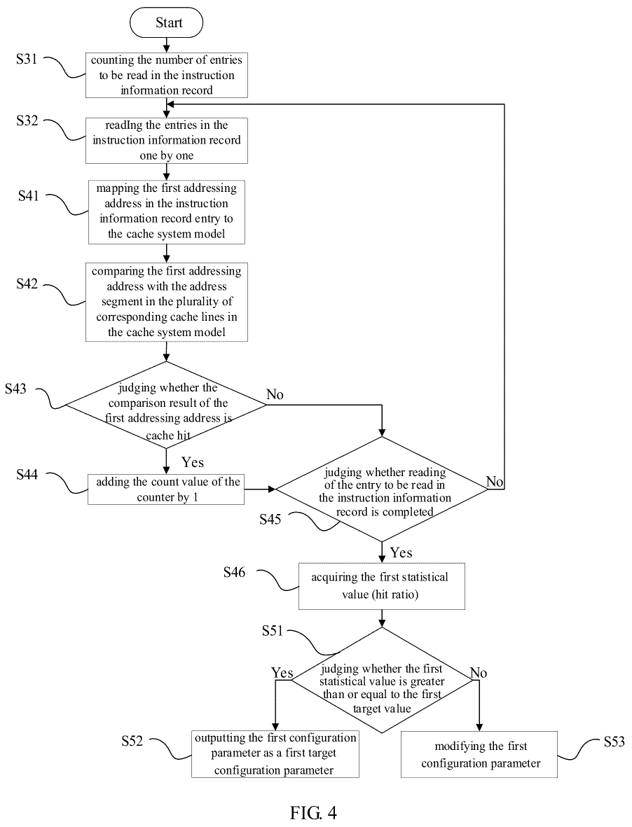

FIG. 4 is a schematic flow chart of an example of steps S30 to S50 in FIG. 2;

For example, as shown in FIG. 4, the count value includes a first count value, the statistical data includes a first statistical value, and the target data includes a first target value. For example, in the example of FIG. 4, the first statistical value is a hit ratio, and the first target value is a target hit ratio.

For example, as shown in FIG. 4, firstly, based on the cache system model acquired in step S10 and the instruction information record acquired in step S20, the script of the cache system model starts to be run in a “Start” stage. For example, as described above, the instruction information record may be trace log instruction information which is directly acquired through a hardware platform or an open source website.

Then, step S30 as shown in FIG. 2 is executed. For example, in step S31, the number of entries to be read in the instruction information record (e.g., the number of request instructions to be read in the trace log instruction information) is counted; in the example of

FIG. 4, the number of entries to be read in the information record is m, and m is an integer greater than 1.

For example, in step S32, the entries in the instruction information record are read one by one. For example, the script language includes a system function (e.g., a $readfile function) for executing file reading. By calling the system function, the information in the instruction information record may be directly read. For example, in step S32, an entry in the instruction information record (e.g., a line in the trace log instruction information) may be read, to acquire information such as a request instruction in the entry, a first addressing address corresponding to the request instruction, etc.

For example, continue to execute step S40 as shown in FIG. 2. For example, in the example of FIG. 4, step S40 as shown in FIG. 2 includes: mapping m first addressing addresses into the cache system model (e.g., m is the number of entries to be read in the information record counted in step S31); comparing the m first addressing addresses with address segments in a plurality of corresponding cache lines in the cache system model; and in response to a comparison result of i first addressing addresses being cache hit, updating the first count value in the statistics counter to i, where, i is a positive integer not greater than m. For example, according to the first count value, the first statistical value may be acquired as i/m.

For example, as shown in FIG. 4, in step S41, the first addressing address in the instruction information record entry read in step S32 is mapped to the cache system model, for example, mapping of the first addressing address to the first configuration parameter in the cache system model is mainly completed; the first configuration parameter includes way, set, bank or replacement strategy, etc. Specifically, for example, in step S42, the first addressing address is compared with the address segment (tag) in the plurality of corresponding cache lines in the cache system model.

For example, in step S43, it is judged whether the comparison result of the first addressing address is cache hit: in response to the comparison result of the first addressing address being cache hit, in step S44, the count value of the counter is added by 1, and then proceed to step S45; in response to the comparison result of the first addressing address being cache miss, the count value of the counter remains unchanged, and step S45 is directly performed.

For example, in step S45, it is judged whether reading of the entry to be read in the instruction information record is completed: in response to reading of the entry to be read in the instruction information record being completed, step S46 is directly performed; in response to reading of the entry to be read in the instruction information record being uncompleted, return to step S32, in order to read a next entry in the instruction information record and execute the process of steps S41 to S45 for the entry.

For example, in step S46, the number of first addressing addresses mapped to the cache system model is m (e.g., m is the number of entries to be read in the information records counted in step S31); and a final update result of the first count value in the statistics counter is i, that is, a comparison result of i first addressing addresses is cache hit, so that the first statistical value (hit ratio) is acquired as i/m.

For example, continue to execute step S50 as shown in FIG. 2. For example, as shown in FIG. 4, in step S51, it is judged whether the first statistical value is greater than or equal to the first target value: in response to the first statistical value being greater than or equal to the first target value, the first configuration parameter is output as a target first configuration parameter in step S52; and in response to the first statistical value being less than the first target value, the first configuration parameter is modified in step S53.

For example, after modifying the first configuration parameters, the cache system simulating method provided by at least one embodiment of the present disclosure is executed again until the first statistical value acquired is greater than or equal to the first target value (i.e., an optimal first statistical value is acquired).

For example, the first statistical value is the hit ratio; and the first target value is the target hit ratio. For example, the modifying the first configuration parameter may be modifying ways, sets, banks, or replacement strategies, etc. in the cache system model, to optimize the cache hit ratio.

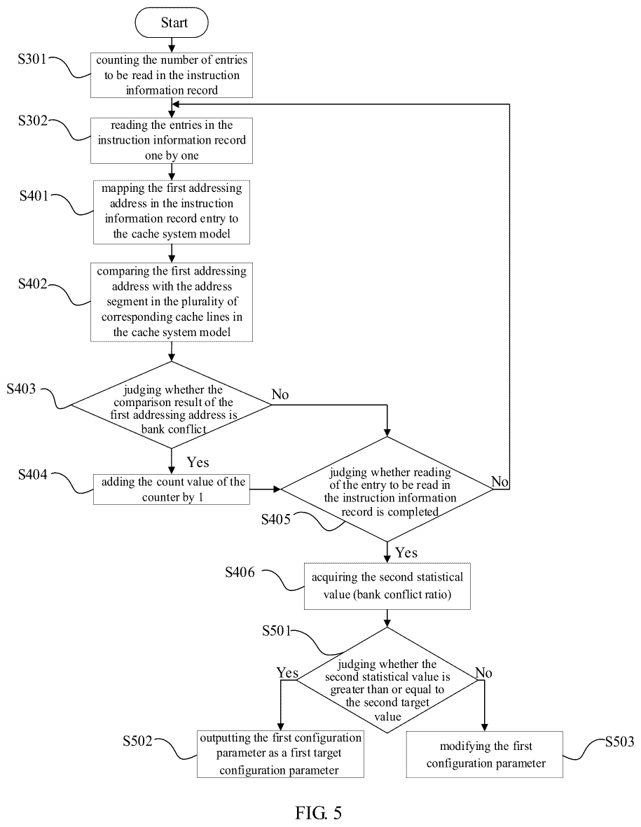

FIG. 5 is a schematic flow chart of another example of steps S30 to S50 in FIG. 2.

For example, as shown in FIG. 5, the count value includes a second count value, the statistical data includes a second statistical value, and the target data includes a second target value. For example, in the example of FIG. 5, the second statistical value is a bank conflict ratio, and the second target value is a target bank conflict ratio.

For example, as shown in FIG. 5, firstly, based on the cache system model acquired in step S10 and the instruction information record acquired in step S20, the script of the cache system model starts to be run in the “Start” stage. For example, similarly, the instruction information record may be the trace log instruction information which is directly acquired through a hardware platform or an open source website.

Then, step S30 as shown in FIG. 2 is executed. For example, in step S301, the number of entries to be read in the instruction information record (e.g., the number of request instructions to be read in the trace log instruction information) is counted. In the example of FIG. 5, the number of entries to be read in the information record is n, and n is an integer greater than 1.

For example, in step S302, the entries in the instruction information record are read one by one. For example, the script language includes a system function (e.g., a $readfile function) for executing file reading. By calling the system function, the information in the instruction information record may be directly read. For example, in step S302, an entry in the instruction information record (e.g., a line in the trace log instruction information) may be read, to acquire information such as a request instruction in the entry, a first addressing address corresponding to the request instruction, etc.

For example, continue to execute step S40 as shown in FIG. 2. For example, in the example of FIG. 5, step S40 as shown in FIG. 2 includes: mapping n first addressing addresses into the cache system model (e.g., n is the number of entries to be read in the information record counted in step S301); comparing the n first addressing addresses with address segments in a plurality of corresponding cache lines in the cache system model; and in response to a comparison result of j first addressing addresses being bank conflict, updating the second count value in the statistics counter to j, where j is a positive integer not greater than n. For example, according to the second count value, the second statistical value is acquired as j/n.

For example, as shown in FIG. 5, in step S401, the first addressing address in the instruction information record entry read in step S302 is mapped to the cache system model, for example, the mapping of the first addressing address to the first configuration parameter in the cache system model is mainly completed; the first configuration parameter includes way, set, bank or replacement strategy, etc. Specifically, for example, in step S402, the first addressing address is compared with the address segment (tag) in the plurality of corresponding cache lines in the cache system model.

For example, in step S403, it is judged whether the comparison result of the first addressing address is bank conflict: in response to the comparison result of the first addressing address being bank conflict, in step S404, the count value of the counter is added by 1, and then proceed to step S405; in response to the comparison result of the first addressing address being not bank conflict, the count value of the counter remains unchanged, and step S405 is directly performed.

For example, in step S405, it is judged whether reading of the entry to be read in the instruction information record is completed: in response to reading of the entry to be read in the instruction information record being completed, step S406 is directly performed; in response to reading of the entry to be read in the instruction information record being uncompleted, return to step S302, in order to read a next entry in the instruction information record and execute the process of steps S401 to S405 for the entry.

For example, in step S406, the number of first addressing addresses mapped to the cache system model is n (e.g., n is the number of entries to be read in the information records counted in step S301), and a final update result of the second count value in the statistics counter is j, that is, a comparison result of j first addressing addresses is bank conflict, so that the second statistical value (bank conflict ratio) is acquired as j/n.

For example, continue to execute step S50 as shown in FIG. 2. For example, as shown in FIG. 5, in step S501, it is judged whether the second statistical value is less than or equal to the second target value: in response to the second statistical value being less than or equal to the second target value, the first configuration parameter is output as the target first configuration parameter in step S502; in response to the second statistical value being greater than the second target value, the first configuration parameter is modified in step S503.

For example, after modifying the first configuration parameter, the cache system simulating method provided by at least one embodiment of the present disclosure is executed again until the second statistical value acquired is less than or equal to the second target value (i.e., an optimal second statistical value is acquired).

For example, the second statistical value is the bank conflict ratio, and the second target value is the target bank conflict ratio. For example, the modifying the first configuration parameter may be modifying ways, sets, banks, or replacement strategies, etc. in the cache system model to achieve a minimize bank conflict.

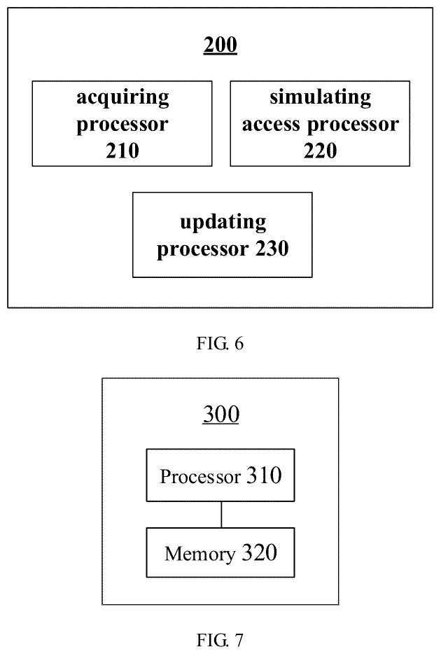

FIG. 6 is a schematic block diagram of an apparatus for cache system simulation provided by at least one embodiment of the present disclosure.

For example, at least one embodiment of the present disclosure provides an apparatus for cache system simulation. As shown in FIG. 6, the apparatus 200 includes an acquiring circuit 210, a simulating access circuit 220, and an updating circuit 230.

For example, the acquiring circuit 210 is configured to acquire a cache system model and acquire an instruction information record. For example, the instruction information record includes a plurality of entries; each entry of the plurality of entries includes a request instruction and a first addressing address corresponding to the request instruction. That is, the acquiring circuit 210 may be configured to execute steps S10 to S20 shown in FIG. 2.

For example, the simulating access circuit 220 is configured to read at least one entry of the plurality of entries from the instruction information record, simulate access to the cache system model by using the request instruction and the first addressing address in each entry of at least one entry to acquire statistical data of the cache system model. That is, the simulating access circuit 220 may be configured to execute steps S30 to S40 shown in FIG. 2.

For example, the updating circuit 230 is configured to update the cache system model based on the statistical data. That is, the updating circuit 230 may be configured to execute step S50 shown in FIG. 2.

Since in the process of, for example, the cache system simulating method shown in FIG. 2 as described above, details of the content involved in the operation of the apparatus 200 for cache system simulation have been introduced, no details will be repeated here for sake of brevity, and the above description about FIG. 1 to FIG. 5 may be referred to for the relevant details.

It should be noted that the above-described respective circuits in the apparatus 200 for cache system simulation shown in FIG. 6 may be configured as software, hardware, firmware, or any combination of the above that executes specific functions, respectively. For example, these circuits may correspond to a special purpose integrated circuit, or may also correspond to a pure software code, or may also correspond to circuits combining software and hardware. As an example, the apparatus described with reference to FIG. 6 may be a PC computer, a tablet apparatus, a personal digital assistant, a smart phone, a web application or other apparatus capable of executing program instructions, but is not limited thereto.

In addition, although the apparatus 200 for cache system simulation is divided into circuits respectively configured to execute corresponding processing when described above, it is clear to those skilled in the art that the processing executed by respective circuits may also be executed without any specific circuit division in the apparatus or any clear demarcation between the respective circuits. In addition, the apparatus 200 for cache system simulation as described above with reference to FIG. 6 is not limited to including the circuits as described above, but may also have some other circuits (e.g., a storing circuit, a data processing circuit, etc.) added as required, or may also have the above-described circuits combined.

At least one embodiment of the present disclosure further provides a device for cache system simulation; the device includes a processor and a memory; the memory includes computer programs; the computer programs are stored in the memory and configured to be executed by the processor; and the computer programs are used to implement the above-described cache system simulating method provided by embodiments of the present disclosure.

FIG. 7 is a schematic block diagram of a device for cache system simulation provided by at least one embodiment of the present disclosure.

For example, as shown in FIG. 7, the device 300 for cache system simulation includes a processor 310 and a memory 320. For example, the memory 320 is configured to store non-transitory computer readable instructions (e.g., computer programs). The processor 310 is configured to execute the non-transitory computer readable instructions; and when executed by the processor 310, the non-transitory computer readable instructions may implement one or more steps according to the cache system simulating method as described above. The memory 320 and the processor 310 may be interconnected through a bus system and/or other form of connection mechanism (not shown).

For example, the processor 310 may be a Central Processing Unit (CPU), a Digital Signal Processor (DSP), or other form of processing unit having a data processing capability and/or a program execution capability, for example, a Field Programmable Gate Array (FPGA), etc.; for example, the Central Processing Unit (CPU) may be an X86 or ARM architecture. The processor 310 may be a general purpose processor or a special purpose processor, and may control other components in the self-adaptive voltage and frequency adjusting device 300 to execute desired functions.

For example, the memory 320 may include any combination of one or more computer program products; and the computer program products may include various forms of computer readable storage media, for example, a volatile memory and/or a non-volatile memory. The volatile memory may include, for example, a Random Access Memory (RAM) and/or a cache, or the like. The non-volatile memory may include, for example, a Read Only Memory (ROM), a hard disk, an Erasable Programmable Read Only Memory (EPROM), a Portable Compact Disk Read Only Memory (CD-ROM), a USB memory, a flash memory, or the like. Computer programs may be stored on the computer readable storage medium, and the processor 310 may run the computer programs, to implement various functions of the device 300. Various applications and various data, as well as various data used and/or generated by the applications may also be stored on the computer readable storage medium.

It should be noted that in the embodiments of the present disclosure, the above description of the cache system simulating method provided by at least one embodiment of the present disclosure may be referred to for specific functions and technical effects of the device 300 for cache system simulation, and no details will be repeated here.

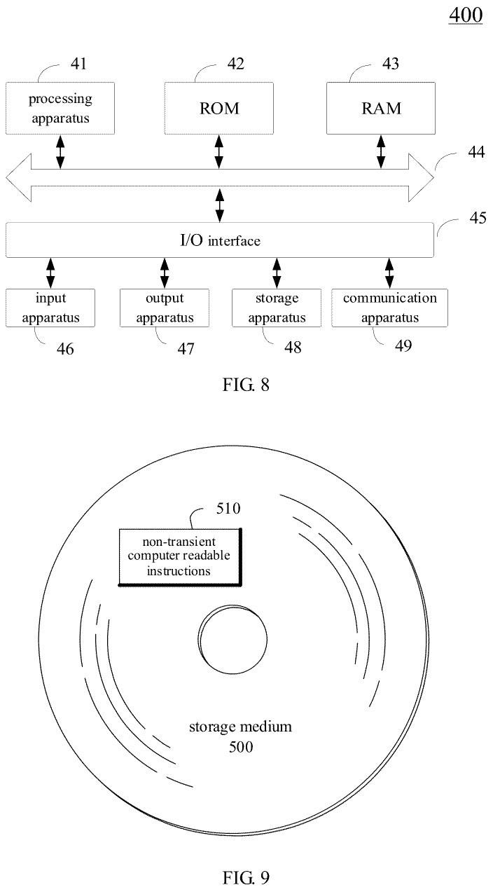

FIG. 8 is a schematic block diagram of another device for cache system simulation provided by at least one embodiment of the present disclosure.

For example, as shown in FIG. 8, the device 400 for cache system simulation, for example, is suitable for implementing the cache system simulating method provided by the embodiment of the present disclosure. It should be noted that the device 400 for cache system simulation shown in FIG. 8 is only an example, and don't impose any limitation on the function and scope of use of the embodiments of the present disclosure.

For example, as shown in FIG. 8, the device 400 for cache system simulation may include a processing apparatus (e.g., a central processing unit, a graphics processor, etc.) 41; the processing apparatus 41 may include, for example, an apparatus for cache system simulation according to any one embodiment of the present disclosure, and may execute various appropriate actions and processing according to a program stored in a Read-Only Memory (ROM) 42 or a program loaded from a storage apparatus 48 into a Random Access Memory (RAM) 43. The Random Access Memory (RAM) 43 further stores various programs and data required for operation of the device 400 for cache system simulation. The processing apparatus 41, the ROM 42, and the RAM 43 are connected with each other through a bus 44. An input/output (I/O) interface 45 is also coupled to the bus 44. Usually, apparatuses below may be coupled to the I/O interface 45: input apparatuses 46 including, for example, a touch screen, a touch pad, a keyboard, a mouse, a camera, a microphone, an accelerometer, a gyroscope, etc.; output apparatuses 47 including, for example, a Liquid Crystal Display (LCD), a speaker, a vibrator, etc.; storage apparatuses 48 including, for example, a magnetic tape or a hard disk, etc.; and a communication apparatus 49. The communication apparatus 49 may allow the device 400 for cache system simulation to perform wireless or wired communication with other electronic device so as to exchange data.

Although FIG. 8 shows the device 400 for cache system simulation with various apparatuses, it should be understood that, it is not required to implement or have all the apparatuses shown, and the device 400 may alternatively implement or have more or fewer apparatuses.

The above description of the cache system simulating method may be referred to for detailed description and technical effects of the device 400 for cache system simulation, and no details will be repeated here.

FIG. 9 is a schematic diagram of a storage medium provided by at least one embodiment of the present disclosure.

For example, as shown in FIG. 9, the storage medium 500 is configured to store non-transitory computer readable instructions 510. For example, when executed by a computer, the non-transitory computer readable instructions 510 may execute one or more steps in the cache system simulating method as described above.

For example, the storage medium 500 may be applied to the above-described device 300 for cache system simulation. For example, the storage medium 500 may be a memory 320 in the device 300 shown in FIG. 7. For example, the corresponding description of the memory 320 in the device 300 for cache system simulation shown in FIG. 7 may be referred to for relevant description of the storage medium 500, and no details will be repeated here.

The technical effects of the in-memory computing processing apparatus provided by the embodiments of the present disclosure may be referred to the corresponding descriptions of the parallel acceleration method and the in-memory computing processor in the above embodiments, which will not be repeated here.

The following points need to be noted:

(1) In the drawings of the embodiments of the present disclosure, only the structures related to the embodiments of the present disclosure are involved, and other structures may refer to the common design(s).

(2) In case of no conflict, features in one embodiment or in different embodiments of the present disclosure may be combined.

The above are merely particular embodiments of the present disclosure but are not limitative to the scope of the present disclosure; any of those skilled familiar with the related arts may easily conceive variations and substitutions in the technical scopes disclosed by the present disclosure, which should be encompassed in protection scopes of the present disclosure. Therefore, the scopes of the present disclosure should be defined in the appended claims.

What is claimed is:

1. A cache system simulating method, comprising:
acquiring a cache system model;
acquiring an instruction information record, wherein the instruction information record comprises a plurality of entries, each entry of the plurality of entries comprises a request instruction and a first addressing address corresponding to the request instruction;
reading at least one entry of the plurality of entries from the instruction information record;
simulating access to the cache system model by using the request instruction and the first addressing address in each entry of the at least one entry to acquire statistical data of the cache system model; and
updating the cache system model based on the statistical data.

2. The simulating method according to claim 1, wherein simulating the access to the cache system model by using the request instruction and the first addressing address in each entry of the at least one entry to acquire the statistical data of the cache system model, comprises:
mapping the first addressing address to the cache system model to acquire a count value in a statistics counter, wherein the cache system model is set to have a first configuration parameter; and
acquiring the statistical data according to the count value.

3. The simulating method according to claim 2, wherein updating the cache system model based on the statistical data, comprises:
comparing the statistical data with target data to update the first configuration parameter.

4. The simulating method according to claim 3, wherein the count value comprises a first count value, the statistical data comprises a first statistical value,
mapping the first addressing address to the cache system model to acquire the count value in the statistics counter, comprises:
mapping m first addressing addresses into the cache system model, wherein m is an integer greater than 1;
comparing the m first addressing addresses with address segments in a plurality of corresponding cache lines in the cache system model; and
in response to a comparison result of i first addressing addresses being cache hit, updating the first count value in the statistics counter to i, wherein i is a positive integer not greater than m.

5. The simulating method according to claim 4, wherein acquiring the statistical data according to the count value, comprises:
acquiring the first statistical value as i/m according to the first count value.

6. The simulating method according to claim 5, wherein the target data comprises a first target value,
comparing the statistical data with the target data to update the first configuration parameter, comprises:
in response to the first statistical value being greater than or equal to the first target value, outputting the first configuration parameter as a target first configuration parameter; or
in response to the first statistical value being less than the first target value, modifying the first configuration parameter.

7. The simulating method according to claim 4, wherein the first statistical value is a hit ratio, and the first target value is a target hit ratio.

8. The simulating method according to claim 3, wherein the count value comprises a second count value, and the statistical data comprises a second statistical value,
mapping the first addressing address to the cache system model to acquire the count value in the statistics counter, comprises:
mapping n first addressing addresses into the cache system model, wherein n is an integer greater than 1;
comparing the n first addressing addresses with address segments in a plurality of corresponding cache lines in the cache system model; and
in response to a comparison result of j first addressing addresses being bank conflict, updating the second count value in the statistics counter to j, wherein j is a positive integer not greater than n.

9. The simulating method according to claim 8, wherein acquiring the statistical data according to the count value comprises:
acquiring the second statistical value as j/n according to the second count value.

10. The simulating method according to claim 9, wherein the target data comprises a second target value,
comparing the statistical data with the target data to update the first configuration parameter comprises:
in response to the second statistical value being less than or equal to the second target value, outputting the first configuration parameter as the target first configuration parameter; or
in response to the second statistical value being greater than the second target value, modifying the first configuration parameter.

11. The simulating method according to claim 8, wherein the second statistical value is a bank conflict ratio, and the second target value is a target bank conflict ratio.

12. The simulating method according to claim 2, wherein the first configuration parameter comprises way, set, bank or replacement strategy.

13. The simulating method according to claim 1, wherein the request instruction comprises a load request instruction or a store request instruction.

14. The simulating method according to claim 2, wherein the request instruction comprises a load request instruction or a store request instruction.

15. The simulating method according to claim 1, further comprising:
creating the cache system model by using a script language.

16. The simulating method according to claim 1, wherein the instruction information comprises trace log instruction information.

17. The simulating method according to claim 2, wherein the instruction information comprises trace log instruction information.

18. An apparatus for cache system simulation, comprising:
an acquiring circuit, configured to acquire a cache system model and acquire an instruction information record, wherein the instruction information record comprises a plurality of entries, each entry of the plurality of entries comprises a request instruction and a first addressing address corresponding to the request instruction;
a simulating access circuit, configured to read at least one entry of the plurality of entries from the instruction information record, simulate access to the cache system model by using the request instruction and the first addressing address in each entry of the at least one entry to acquire statistical data of the cache system model; and
an updating circuit, configured to update the cache system model based on the statistical data.

19. A device for cache system simulation, comprising:
a processor;
a memory, comprising computer programs;
wherein the computer programs are stored in the memory and configured to be executed by the processor, and the computer programs are configured to implement:
acquiring a cache system model;
acquiring an instruction information record, wherein the instruction information record comprises a plurality of entries, each entry of the plurality of entries comprises a request instruction and a first addressing address corresponding to the request instruction;
reading at least one entry of the plurality of entries from the instruction information record;
simulating access to the cache system model by using the request instruction and the first addressing address in each entry of the at least one entry to acquire statistical data of the cache system model; and
updating the cache system model based on the statistical data.

20. A storage medium, configured to store non-transitory computer readable instructions;
wherein, when executed by a computer, cause the non-transitory computer readable instructions to implement the simulating method according to claim 1.
